(19) United States
(12) Patent Application Publication
(10) Pub. No.: US 2020/0012467 A1
(43) Pub. Date: Jan. 9, 2020

(54) IMAGE FORMING SYSTEM, INFORMATION PROCESSING APPARATUS

(71) Applicant: KYOCERA Document Solutions Inc., Osaka (JP)

(72) Inventor: Naoki Sekioka, Osaka (JP)

(21) Appl. No.: 16/502,654

(22) Filed: Jul. 3, 2019

(30) Foreign Application Priority Data
Jul. 6, 2018 (JP) 2018-129144

(51) Int. Cl. G06F 3/12; G06F 21/31

(52) U.S. Cl. CPC G06F 3/1274; G06F 3/1238; G06F 3/126; G06F 21/31

(57) ABSTRACT

An image forming system includes: an image forming apparatus that receives print jobs via a network and performs outputs corresponding to the received print jobs; and an information processing apparatus that includes an information processing apparatus side control portion that causes a user to input cancel information, stores the cancel information in a storage portion, and then upon operation of an operation key, transmits the cancel information to the image forming apparatus. The image forming apparatus includes an image forming apparatus side control portion that, when the user is recognized as a registered cancel-accepted user based on the user authentication information in the cancel information, deletes, among the received print jobs registered in a job queue, print jobs that are identified based on the filtering information in the cancel information.

### INCORPORATION BY REFERENCE

This application is based upon and claims the benefit of priority from the corresponding Japanese Patent Application No. 2018-129144 filed on Jul. 6, 2018, the entire contents of which are incorporated herein by reference.

### BACKGROUND

The present disclosure relates to an image forming system in which a print job waiting in a queue in an image forming apparatus can be cancelled, and to an information processing apparatus that is used in the image forming system together with the image forming apparatus.

After transmitting a print job to a printer (an image forming apparatus), a user may find an erroneous print setting of the print job and cancel an output corresponding to the print job. In general, an operation to cancel an output is performed on the image forming apparatus side. In that case, however, when many users are using the image forming apparatus, an output (a print job) that is to be cancelled needs to be specified and identified appropriately.

In connection with the above-mentioned problem, there is known a related technology in which print jobs for which cancels are to be accepted are preliminarily set for each of a plurality of users or for each of a plurality of passwords set, and when a user performs an operation for canceling a print job to an image forming apparatus, an authentication of the user is performed, and if the print job matches any one of the preliminarily set cancel-accepted print jobs, the print job is cancelled. With this configuration, in a case where a plurality of print jobs have been input by a plurality of users, only cancel-accepted print jobs are appropriately cancelled, and print jobs other than the cancel-accepted print jobs are continued to be executed. That is, it is possible to allow an operation for canceling a print job to be performed appropriately.

### SUMMARY

An image forming system according to an aspect of the present disclosure includes an image forming apparatus and an information processing apparatus. The image forming apparatus receives one or more print jobs via a network and performs one or more outputs corresponding to the received one or more print jobs. The information processing apparatus is connected with the image forming apparatus via the network. In the image forming apparatus, a cancel-accepted user who has an authority to delete a print job waiting in a queue, is set. The information processing apparatus includes a storage portion and an information processing apparatus side control portion. The storage portion stores user authentication information and filtering information as a group of cancel information, the user authentication information being used to perform an authentication to determine whether or not a user is the cancel-accepted user, the filtering information being used to identify a print job to be deleted. The information processing apparatus side control portion causes the user to input the group of cancel information, stores the group of cancel information in the storage portion, and then upon operation of an operation key, transmits the group of cancel information to the image forming apparatus. The image forming apparatus includes an image forming apparatus side control portion that, when the user is recognized as the cancel-accepted user based on the user authentication information in the group of cancel information, deletes, among the received one or more print jobs registered in a job queue, one or more print jobs that are identified based on the filtering information in the group of cancel information.

An information processing apparatus according to another aspect of the present disclosure is connected with, via a network, an image forming apparatus that receives one or more print jobs via the network and performs one or more outputs corresponding to the received one or more print jobs. In the image forming apparatus, a cancel-accepted user who has an authority to delete a print job waiting in a queue, is set. The information processing apparatus includes a storage portion and a control portion. The storage portion stores user authentication information and filtering information as a group of cancel information, the user authentication information being used to perform an authentication to determine whether or not a user is the cancel-accepted user, the filtering information being used to identify a print job to be deleted. The control portion causes the user to input the group of cancel information, stores the group of cancel information in the storage portion, and then upon operation of an operation key, transmits the group of cancel information to the image forming apparatus, thereby allowing the image forming apparatus to, when the user is recognized as the cancel-accepted user, delete one or more print jobs that are identified based on the filtering information.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing an entire configuration of an image forming system according to an embodiment of the present disclosure.

FIG. 2 is a diagram showing a configuration of an information processing apparatus used in the image forming system according to the embodiment of the present disclosure.

FIG. 3 is a diagram showing a configuration of an image forming apparatus used in the image forming system according to the embodiment of the present disclosure.

FIG. 4 is a diagram showing an example of content of a job queue in the image forming apparatus used in the image forming system according to the embodiment of the present disclosure.

FIG. 5 is a diagram showing an example of a screen displayed to allow for generation of cancel information in the information processing apparatus used in the image forming system according to the embodiment of the present disclosure.

FIG. 6 is a diagram showing an example of a screen from which a cancel of a print job can be instructed on the information processing apparatus used in the image forming system according to the embodiment of the present disclosure.

FIG. 7 is a flowchart showing an operation of the image forming apparatus used in the image forming system according to the embodiment of the present disclosure.

FIG. 8A, FIG. 8B and FIG. 8C are diagrams showing examples of filtering information in the image forming system according to the embodiment of the present disclosure.

### DETAILED DESCRIPTION

In the above-described related technology, the operation for cancelling a print job is performed on the image forming apparatus side. As a result, when a user of a personal computer that is located away from the image forming apparatus wants to cancel a print job that was transmitted from the personal computer to the image forming apparatus, the user needs to move to the location of the image forming apparatus and input a user ID and a password to the image forming apparatus. In such a case, it is impossible to cancel a print job speedily. On the other hand, in an image forming system according to the present disclosure, it is possible to cancel, speedily and appropriately, a print job waiting in a queue in an image forming apparatus.

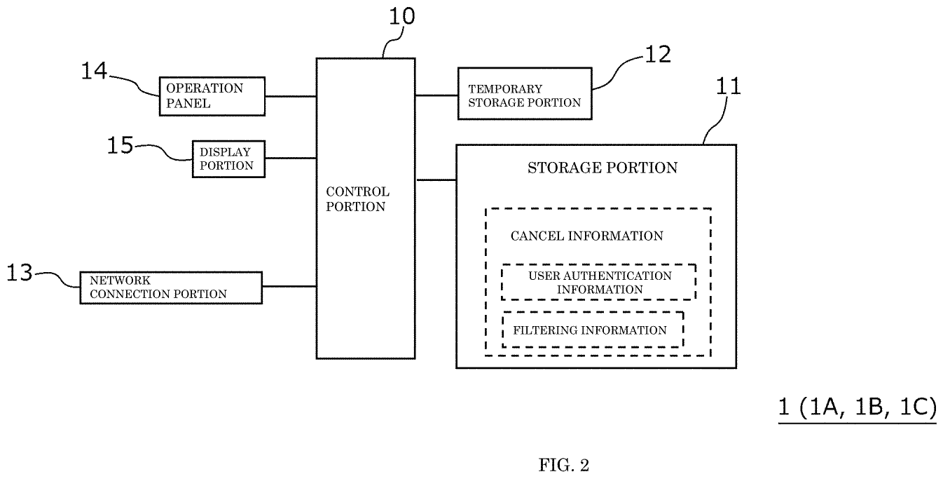

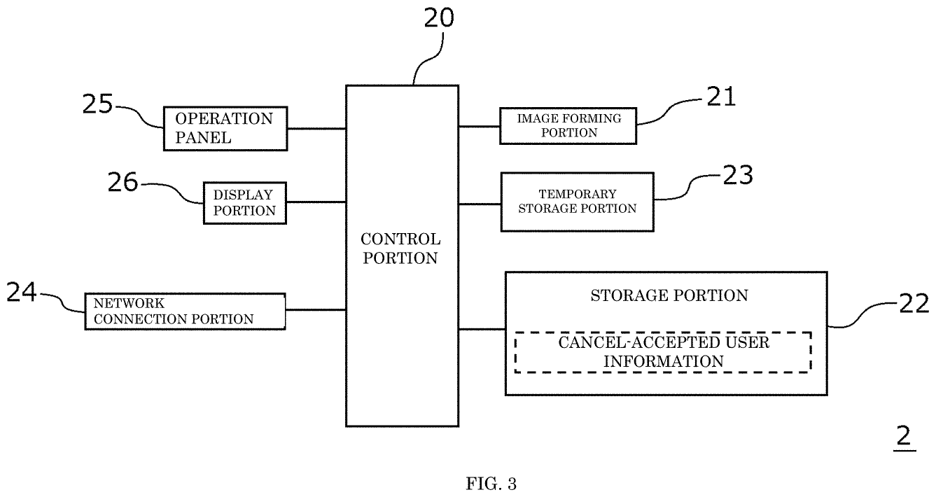

The following describes an image forming system according to an embodiment of the present disclosure. The image forming system is composed of a plurality of personal computers (computers: information processing apparatuses) 1 (1A, 1B, 1C) and an image forming apparatus 2 that are connected with each other via a network N. FIG. 2 is a diagram showing a configuration of each of the personal computers 1. FIG. 3 is a diagram showing a configuration of the image forming apparatus 2.

As shown in FIG. 2, each of the personal computers 1 includes a control portion (information processing apparatus side control portion) 10, a storage portion 11, a temporary storage portion 12, and a network connection portion 13. The control portion 10 includes a CPU, a ROM and the like. The CPU controls the whole apparatus. The ROM stores programs. The storage portion 11 is, for example, a nonvolatile memory or a hard disk and stores various types of data. As with the storage portion 11, the temporary storage portion 12 stores various types of data, but is a volatile storage such as a DRAM. The network connection portion 13 is an interface to connect with the network N. Each of the personal computers 1 also includes an operation panel 14 and a display portion 15. The operation panel 14 is configured to receive instructions from users. The display portion 15 includes a display to display information that is necessary when receiving the instructions from the users. The configurations of these components are the same as those of normal personal computers.

As shown in FIG. 3, the image forming apparatus 2 includes a control portion (image forming apparatus side control portion) 20 and an image forming portion 21. The control portion 20 controls the whole apparatus. The image forming portion 21 performs a process of forming an image pattern with toner on a medium and outputting the medium with the image pattern formed thereon. In addition, similar to the personal computers 1, the image forming apparatus 2 includes a storage portion 22, a temporary storage portion 23, a network connection portion 24, an operation panel 25, and a display portion 26.

As with known image forming apparatuses, the image forming apparatus 2 receives print jobs from the computers 1 via the network connection portion 13, and causes the image forming portion 21 to perform outputs corresponding to the received print jobs. In particular, when a plurality of print jobs are received simultaneously or in a short time period, the control portion 20 generates, for the purpose of executing the print jobs appropriately, a job queue, namely, a print job queue, by using the temporary storage portion 23 and the storage portion 22, and executes the print jobs according to the job queue. The print jobs are registered in the job queue. Thereafter, the order of the print jobs in the job queue may be adjusted by the control portion 20. The print jobs are output by the image forming portion 21 in the order of registration with the job queue, or in an order after adjustment by the control portion 20.

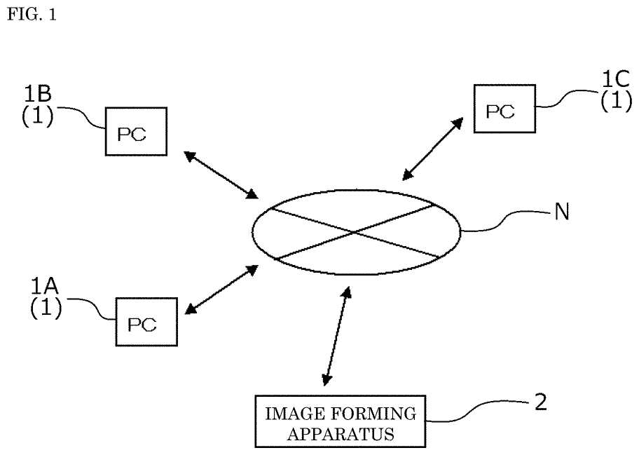

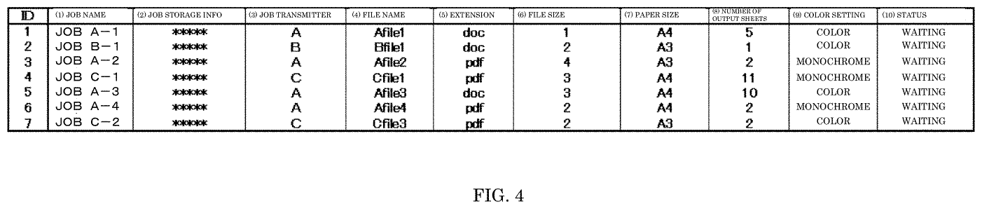

FIG. 4 is a diagram showing an example of the registration content of the job queue in the image forming apparatus 2. In this example, the following are registered (stored) and managed in correspondence with each of the IDs (1 to 7): (1) a job name of a print job; (2) storage information of the print job (e.g. a memory address); (3) a name of a transmitter of the print job (any one of the computers 1A, 1B and 1C shown in FIG. 1); (4) a file name of a document or the like that is output by the print job; (5) a file extension of the file; (6) a file size of the file; (7) a paper size used in the output of the print job; (8) the number of paper sheets output by the print job; (9) a color setting of the print job (color/monochrome); and (10) execution state of the print job. It is noted that information (4) to (9) described above may not be stored if they can be identified from information (1) and (2). In this example, the following seven jobs have been sequentially transmitted from the computers shown in FIG. 1: the job A-1 from the computer 1A; the job B-1 from the computer 1B; the job A-2 from the computer 1A; the job C-1 from the computer 1C; the job A-3 from the computer 1A; the job A-4 from the computer 1A; and the job C-2 from the computer 1C. For each of the print jobs, information (2) to (10) are recognized.

In the image forming apparatus 2, in a case where a plurality of print jobs have been registered in the job queue as in the above-described example, it is possible for the computers 1 side to cancel a print job, namely, delete a print job from the job queue. The following describes the operation. Here, for performance of the operation, a user (a cancel-accepted user) who executes the canceling is identified, distinguished from a transmitter of the print job (any one of the computers 1A, 1B and 1C). The login ID of the cancel-accepted user is stored, in association with a password, in the storage portion 22 as cancel-accepted user information.

On the other hand, a user who cancels a print job operates the operation panel 14 of one of the computers 1. When the user is a cancel-accepted user, the print job specified by the operation is deleted from the job queue in the image forming apparatus 2. As a result, a login ID and a password of the cancel-accepted user are input, as user authentication information, to the computer 1 via the operation panel 14.

In addition, filtering information is input by the user on the operation panel 14. The filtering information is used to identify a print job(s) to be deleted, among the print jobs registered in the job queue. The filtering information includes, for example, (A) a character sequence constituting a part of a file name of a file that is output by the print job to be deleted; (B) a file extension of the file; (C) a lower limit of a file size of the file; (D) a paper size used in the output of the print job; (E) a lower limit of the number of paper sheets output by the print job; and (F) a color setting of the print job. The information (A) to (F) correspond to the information (4) to (9) in the job queue. When the file name of a print job includes the character sequence specified in the filtering information (A), the print job is recognized as a print job to be deleted. When the file extension of a print job matches the file extension specified in the filtering information (B), the print job is recognized as a print job to be deleted. When the paper size used in the output of a print job matches the paper size specified in the filtering information (D), the print job is recognized as a print job to be deleted. When the color setting (color/monochrome) of a print job matches the color setting specified in the filtering information (F), the print job is recognized as a print job to be deleted. When the file size of the file of a print job is equal to or larger than the lower limit specified in the filtering information (C), the print job is recognized as a print job to be deleted. When the number of paper sheets output by a print job is equal to or larger than the lower limit specified in the (E), the print job is recognized as a print job to be deleted.

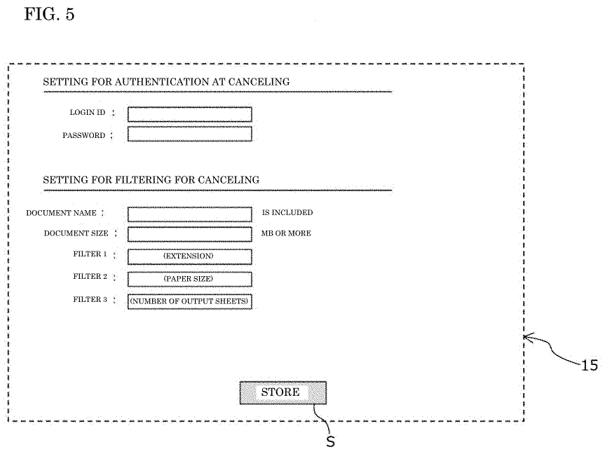

FIG. 5 shows an example of a screen that the control portion 10 displays on the display portion 15 of a touchpanel display, to allow input of the user authentication information and the filtering information. Any of the above-described information (5), (7) to (9) are set as items of filters 1 to 3. In this example, the information (5), (7) and (8) are respectively set as the filters 1, 2 and 3. When the user inputs the information for the filters 1, 2 and 3 and operates a STORE key S, the control portion 10 stores the input information (the user authentication information, the filtering information) in the storage portion 11 as a group of cancel information. After this, when canceling of a print job is executed, the cancel information is read and used. It is noted that in FIG. 5, the input of the login ID and the password (the user authentication information) is mandatory, and the input of the information below the password is not mandatory.

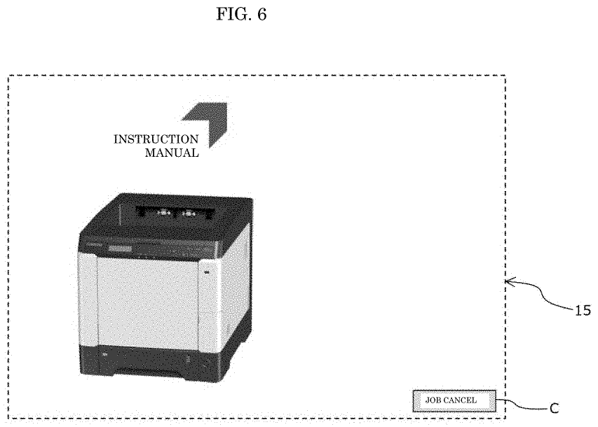

After the above-described input is completed, and the cancel information is stored in the storage portion 11, another operation can be performed on the computer 1. FIG. 6 shows an example of a screen that is displayed, in such a case, on the display portion 15. In this example, an instruction manual of the image forming apparatus 2 is viewed. Here, a small operation key, namely, a JOB CANCEL key C, is provided at a corner of the screen. When the JOB CANCEL key C is operated, the control portion 10 reads the cancel information from the storage portion 11, and transmits the cancel information to the image forming apparatus 2 via the network N. Not limited to the cancel-accepted user, any user can operate the JOB CANCEL key C.

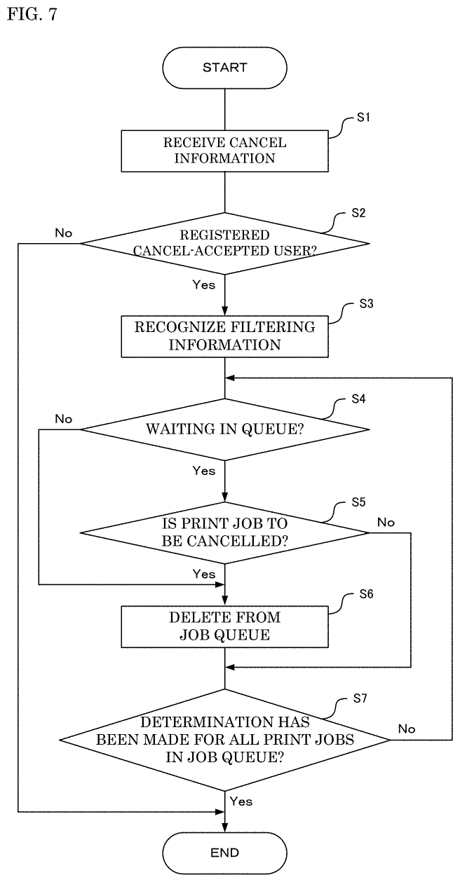

FIG. 7 is a flowchart of the operation of the control portion 20 of the image forming apparatus 2 that is performed after the image forming apparatus 2 receives the cancel information from the computer 1A (S1). First, the control portion 20 consults the cancel-accepted user information stored in the storage portion 22 and determines whether or not a user who generated the received cancel information has been registered as a cancel-accepted user (S2). When it is determined that the user who generated the received cancel information has not been registered as a cancel-accepted user (S2: No), the subsequent process is not executed. That is, canceling of the print job is not performed at all.

When it is determined that the user who generated the received cancel information has been registered as a cancel-accepted user (S2: Yes), the control portion 10 recognizes the filtering information (A) to (F) (S3). Subsequently, the control portion 10 determines, for each of the print jobs registered in the job queue (FIG. 4), whether or not a print job is to be deleted. The determination is performed individually for each of the print jobs in the queue.

Here, first, the control portion 10 determines whether or not the determination-target print job is waiting in queue (S4). When it is determined that the print job is not waiting in queue (is in execution) (S4: No), the print job is not cancelled.

When it is determined that the print job is waiting in queue (is not in execution) (S4: Yes), the control portion 10 determines whether or not the print job is to be cancelled (S5). In this example, the image forming apparatus 2 recognizes that the cancel information has been transmitted from the computer 1A. Thus the jobs other than the jobs A-1, A-2, A-3 and A-4 are not to be cancelled.

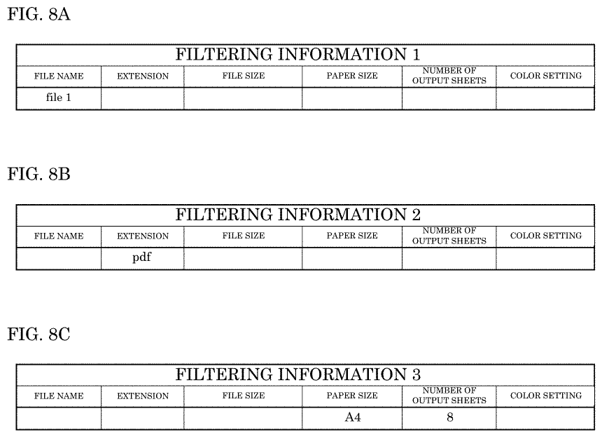

With regard to the jobs A-1, A-2, A-3 and A-4, a further determination is made based on the filtering information. Here, a description is given for a case where there are three types of filtering information shown in FIG. 8A, FIG. 8B and FIG. 8C (filtering information 1 to 3). In the case of the filtering information 1, only the job A-1 whose file name includes “file 1” is to be cancelled, and the other print jobs are not to be cancelled. In the case of the filtering information 2, only the jobs A-2 and A-4 that have extension “pdf” are to be cancelled, and the other print jobs are not to be cancelled. In the case of the filtering information 3, only the job A-3 that outputs A4 paper sheets and outputs 8 (eight) or more paper sheets is to be cancelled, and the other print jobs are not to be cancelled. The print job(s) determined to be cancelled is deleted from the job queue (S6). Thus the image forming portion 21 does not perform output for the print job(s) determined to be cancelled.

When it is determined that the above-described determination (S5) and the deletion of the print job(s) to be cancelled from the job queue (S6) have been performed for each of all the print jobs in the job queue (S7: Yes), the control portion 10 ends the process.

It is noted that if, during the above-described operation, none of the filtering information shown in FIG. 5 is input, all of the jobs A-1, A-2, A-3 and A-4 that have been transmitted from the computer 1A that transmitted the cancel information, are cancelled.

In the above-described example, only the print jobs transmitted from the computer 1 that has transmitted the cancel information are cancelled. The limitation, however, may not be necessary. For example, print jobs may be cancelled as follows in correspondence with the three types of filtering information shown in FIG. 8A, FIG. 8B and FIG. 8C: in the case of the filtering information 1 (FIG. 8A), the jobs A-1, B-1 and C-1 that have “file1” as a part of the file name are to be cancelled; in the case of the filtering information 2 (FIG. 8B), the jobs A-2, C-1, A-4 and C-2 that have extension “pdf” are to be cancelled; and in the case of the filtering information 3 (FIG. 8C), the jobs C-1 and A-3 that output A4 paper sheets and output 8 (eight) or more paper sheets are to be cancelled. In this case, the cancel-accepted user can use any one of the computers 1A, 1B and 1C shown in FIG. 1 to cancel a desired print job(s).

In this case, when the cancel-accepted user who has performed the operation generates and stores the cancel information in each of the computers, another user can cancel a print job. This reduces the time required for this operation. In this case, in order to prevent mis-cancel of a print job that should not be cancelled, the filtering information may be set in more detail. For example, file names of files to be output and “file name” in FIG. 8A, FIG. 8B and FIG. 8C may be set appropriately. In addition, the contents of the items to be set as filtering conditions are not limited to those described above, but may be other various types of items.

In the above-described example, the cancel information is stored in the storage portion 11 of the computer 1 such that the cancel information is held in the storage portion 11 even when the computer 1 is powered off. Not limited to this, however, the cancel information may be stored in the temporary storage portion 12. In this case, the cancel information can be used in a similar manner as far as the computer 1 is not powered off and the cancel information is not deleted.

According to the above-described image forming system, once the cancel information is stored in the storage portion 11, it is possible to cancel a cancel-accepted print job(s) by only operating the JOB CANCEL key C shown in FIG. 6. This makes it possible to perform canceling of a print job(s) speedily and appropriately.

In addition, according to the above-described image forming system, for example, a file of cancel information that has been generated and stored in the computer 1A, can be copied or moved to other computers (1B, 1C) for use. This allows a similar operation to be performed on an arbitrary computer.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming system comprising an image forming apparatus and an information processing apparatus, the image forming apparatus receiving one or more print jobs via a network and performing one or more outputs corresponding to the received one or more print jobs, the information processing apparatus being connected with the image forming apparatus via the network, wherein
in the image forming apparatus, a cancel-accepted user who has an authority to delete a print job waiting in a queue, is set,
the information processing apparatus includes:
a storage portion configured to store user authentication information and filtering information as a group of cancel information, the user authentication information being used to perform an authentication to determine whether or not a user is the cancel-accepted user, the filtering information being used to identify a print job to be deleted; and
an information processing apparatus side control portion configured to cause the user to input the group of cancel information, store the group of cancel information in the storage portion, and then upon operation of an operation key, transmit the group of cancel information to the image forming apparatus, and
the image forming apparatus includes:
an image forming apparatus side control portion configured to, when the user is recognized as the cancel-accepted user based on the user authentication information in the group of cancel information, delete, among the received one or more print jobs registered in a job queue, one or more print jobs that are identified based on the filtering information in the group of cancel information.

2. The image forming system according to claim 1, wherein
the filtering information includes at least one of: a character sequence constituting a part of a file name of a file that is output by the print job to be deleted; a file extension of the file; and a file size of the file.

3. The image forming system according to claim 1, wherein
the filtering information includes at least one of: a paper size used in output of the print job to be deleted; the number of paper sheets output by the print job; and a color setting of the print job.

4. An information processing apparatus connected with, via a network, an image forming apparatus that receives one or more print jobs via the network and performs one or more outputs corresponding to the received one or more print jobs, wherein
in the image forming apparatus, a cancel-accepted user who has an authority to delete a print job waiting in a queue, is set, and
the information processing apparatus comprises:
a storage portion configured to store user authentication information and filtering information as a group of cancel information, the user authentication information being used to perform an authentication to determine whether or not a user is the cancel-accepted user, the filtering information being used to identify a print job to be deleted; and
a control portion configured to cause the user to input the group of cancel information, store the group of cancel information in the storage portion, and then upon operation of an operation key, transmit the group of cancel information to the image forming apparatus, thereby allowing the image forming apparatus to, when the user is recognized as the cancel-accepted user, delete one or more print jobs that are identified based on the filtering information.
